(19) United States
(12) Patent Application Publication
(10) Pub. No.: US 2010/0219231 A1
(43) Pub. Date: Sep. 2, 2010

(54) Braze Ring

(75) Inventors: Stuart Means, Whitehouse, TX (US); Richard Bogan, Lindale, TX (US); Edward Patrick, Murrysville, PA (US)

Correspondence Address: CONLEY ROSE, P.C., 5601 GRANITE PARKWAY, SUITE 750, PLANO, TX, 75024, US

(73) Assignee: TRANE INTERNATIONAL INC., Piscataway, NJ (US)

(21) Appl. No.: 12/782,524

(22) Filed: May 18, 2010

Related U.S. Application Data
(62) Division of application No. 12/362,655, filed on Jan. 30, 2009.
(60) Provisional application No. 61/028,431, filed on Feb. 13, 2008.

(51) Int. Cl. B23K 31/02; B23K 1/20

(52) U.S. Cl. 228/224; 228/246

(57) ABSTRACT

A method of connecting a straight tubular end to a flared tubular end includes locating a substantially annular braze ring substantially concentrically around the straight tubular end, inserting the straight tubular end into the flared tubular end so that the braze ring engages the flared tubular end, and heating the braze ring so that flux separates from an exterior channel of the braze ring and the separated flux from the exterior channel contacts at least one of a faying surface of the flared tubular end and a faying surface of the straight tubular end.

### CROSS-REFERENCE TO RELATED APPLICATIONS

This is a divisional application of the prior filed and co-pending U.S. patent application Ser. No. 12/362,655 filed Jan. 30, 2009 and entitled “Braze Ring,” which is based on and claims the benefit of the earlier filed U.S. Provisional Patent Application No. 61/028,431 filed Feb. 13, 2008 and entitled “H-Channel Pre-Fluxed Braze Ring,” both of which are incorporated herein by reference for all purposes.

### STATEMENT REGARDING FEDERALLY SPONSORED RESEARCH OR DEVELOPMENT

Not Applicable.

### BACKGROUND

Brazing compositions are used to join two metal pieces together by brazing or soldering. The brazing composition is disposed in and/or near a gap between the two metal pieces and then heated to the brazing temperature, which is typically above the melting temperature of the brazing composition but below the melting temperature of the metal pieces to be joined. Once the brazing composition is heated to the melting temperature of the brazing composition, the melted brazing composition conforms to fill the gap between the two metal pieces to form a fillet and seal that bonds the two metal pieces together. In some cases, the melted brazing composition fills the gap between the two metal pieces through capillary action where the melted brazing composition is drawn into the gap between the metal pieces even though the gap is very small.

### SUMMARY OF THE DISCLOSURE

In some embodiments, a braze ring is provided that includes a generally annular body and an outer annular channel formed on an outer surface of the body.

In other embodiments, a method of connecting a straight tubular end to a flared tubular end is provided. The method includes locating a substantially annular braze ring substantially concentrically around the straight tubular end, inserting the straight tubular end into the flared tubular end so that the braze ring engages the flared tubular end, and heating the braze ring so that flux separates from an exterior channel of the braze ring and the separated flux from the exterior channel contacts at least one of a faying surface of the flared tubular end and a faying surface of the straight tubular end.

In other embodiments, a braze ring is provided that includes a body having a substantially symmetric cross-sectional shape forming an inner channel and an outer channel and flux carried within each of the inner channel and the outer channel.

### BRIEF DESCRIPTION OF THE DRAWINGS

FIG. 1 is a schematic side view of a heat exchanger coil assembly comprising an embodiment of a braze ring;

FIG. 2 is a schematic end view of the heat exchanger coil assembly of FIG. 1;

FIG. 3 is an oblique view of the heat exchanger coil assembly of FIG. 1;

FIG. 4 is a cross-sectional side view of an embodiment of a return bend of the heat exchanger coil assembly of FIG. 1, the ends of which are disposed within straight tubular pieces of the heat exchanger coil assembly of FIG. 1, and with braze rings carried on the return bend, adjacent the straight tubular pieces;

FIG. 5 is a partial cross-sectional side view of the braze ring of FIG. 1;

FIG. 6 is an oblique view of the braze ring of FIG. 1;

FIG. 7 is a schematic cross-sectional side view of a step of a method of connecting a flared end of a straight tube to a straight end of a return bend using the braze ring of FIG. 1;

FIG. 8 is a schematic cross-sectional side view of a subsequent step of a method of connecting a flared end of a straight tube to a straight end of a return bend using the braze ring of FIG. 1;

FIG. 9 is a schematic cross-sectional partial side view of another subsequent step of a method of connecting a flared end of a straight tube to a straight end of a return bend using the braze ring of FIG. 1;

FIG. 10 is a schematic cross-sectional partial side view of still another subsequent step of a method of connecting a flared end of a straight tube to a straight end of a return bend using the braze ring of FIG. 1;

FIG. 11 is a schematic cross-sectional partial side view of a final subsequent step of a method of connecting a flared end of a straight tube to a straight end of a return bend using the braze ring of FIG. 1; and

FIG. 12 is a partial cross-sectional side view of an alternative embodiment of a braze ring.

### DETAILED DESCRIPTION

Brazing and soldering methods are used in HVAC assemblies and other systems to join two metal components together using a brazing composition, such as a metal alloy. The brazing composition is positioned between the two components, then melted to form a fillet and seal that bonds the faying surfaces, namely the surfaces of the metal components to be joined. The brazing process may further require a chemical flux to prepare the faying surfaces to accept the metal alloy and thereby result in a stronger bond. The flux and metal alloy have historically been applied as two separate steps and from two different material sources, namely, a source of flux and a separate source of metal alloy.

The present disclosure relates generally to brazing compositions comprising a metal alloy and a flux in one complete form, such as a braze wire; braze rings (in some cases formed from the braze wire); HVAC assemblies incorporating the braze rings; and associated methods of manufacture. While various embodiments of brazing compositions, braze wires, and braze rings are described for use in the context of HVAC assemblies, these components may be used in any brazing or soldering application.

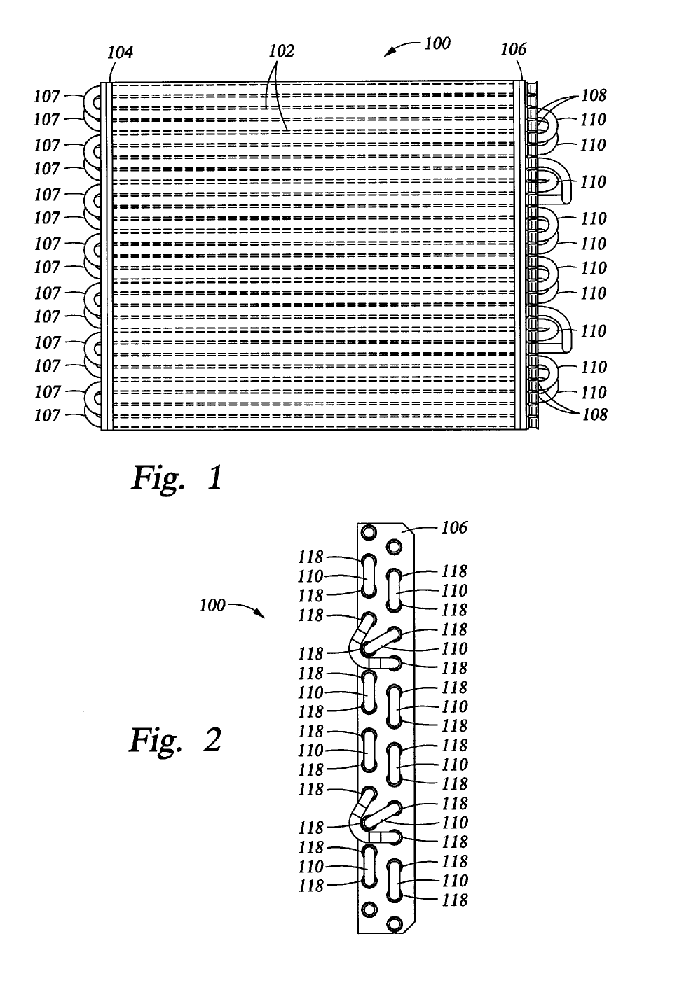

FIGS. 1-4 show an HVAC heat exchanger coil 100 according to an embodiment. FIGS. 1, 2 and 3 depict a schematic side view, a schematic end view and a schematic oblique view, respectively, of the heat exchanger coil 100. FIG. 4 depicts a cross-sectional side view of one representative return bend 110 connecting two representative straight tubes 102 of the heat exchanger coil 100. In this embodiment, the heat exchanger coil 100 comprises a plurality of substantially straight tubes 102 that extend between a first end plate 104 and a second end plate 106. Adjacent pairs of straight tubes 102 are joined in fluid communication near the first end plate 104 by integral bends 107 and near the second end plate 106 by return bends 110. In particular, each integral bend 107 is formed integral with a pair of joined straight tubes 102, while each return bend 110 is joined to respective flared ends 108 of two adjacent straight tubes 102 via brazing, as discussed in detail infra The integral bends 107 extend beyond the first end plate 104, and the flared ends 108 of the straight tubes 102 extend beyond the second end plate 106.

The return bends 110 are generally U-shaped tubes comprising two straight ends 112 connected to each other by a tubular curved link 114. The flared ends 108 of the straight tubes 102 are each configured to receive a straight end 112 of a return bend 110 such that the straight end 112 is received generally concentrically within a constant inner diameter section 116 of the flared end 108 of the straight tube 102. In this embodiment, the sizes of the constant inner diameter section 116 and the straight end 112 are such that when the straight end 112 is inserted within the constant inner diameter section 116, a clearance or gap of about 2 to 3 thousandths of an inch exists.

While this embodiment comprises integral bends 107 for joining straight tubes 102 near the first end plate 104 and return bends 110 for joining straight tubes 102 near the second end plate 106, the configuration of the heat exchanger coil 100 may be altered in any number of different ways. An alternative embodiment of the heat exchanger coil may eliminate the integral bends and instead employ straight tubes comprising flared ends that extend beyond both a first end plate and a second end plate, these flared ends being substantially similar to the flared ends 108 of the straight tubes 102. Of course, in that alternative embodiment, the pairs of straight tubes could be joined together in fluid communication near the first end plate and the second end plate using return bends substantially similar to return bends 110 and in a manner substantially similar to the manner in which flared ends 108 are joined by return bends 110. In still another alternative embodiment, some pairs of straight tubes may be joined together in fluid communication using integral bends while other pairs of straight tubes may be joined via flared ends and associated return bends at or near one or both of a first end plate and a second end plate. In this alternative embodiment, both integral bends and flared ends may be present at or near one or both of the first end plate and the second end plate.

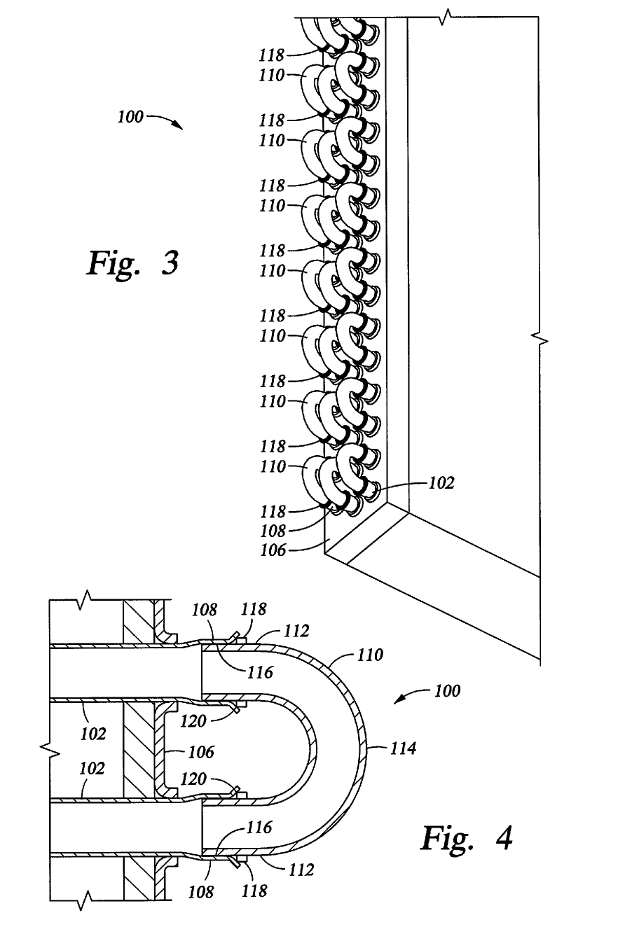

In a non-final stage of assembly, the heat exchanger coil 100 further comprises braze rings 118, shown after being melted into place in FIG. 3 and shown prior to any melting in FIG. 4. Prior to any melting, each braze ring 118 is generally an annular ring-like structure disposed concentrically about the exterior of a straight end 112 of a return bend 110 and also abutted against a lip 120 of the flared end 108 of a straight tube 102. The lips 120 of the flared ends 108 generally extend from the constant inner diameter sections 116 and have an increasing inner diameter along the lengthwise direction of the straight tubes 102 as the distance from the first plate 104 increases.

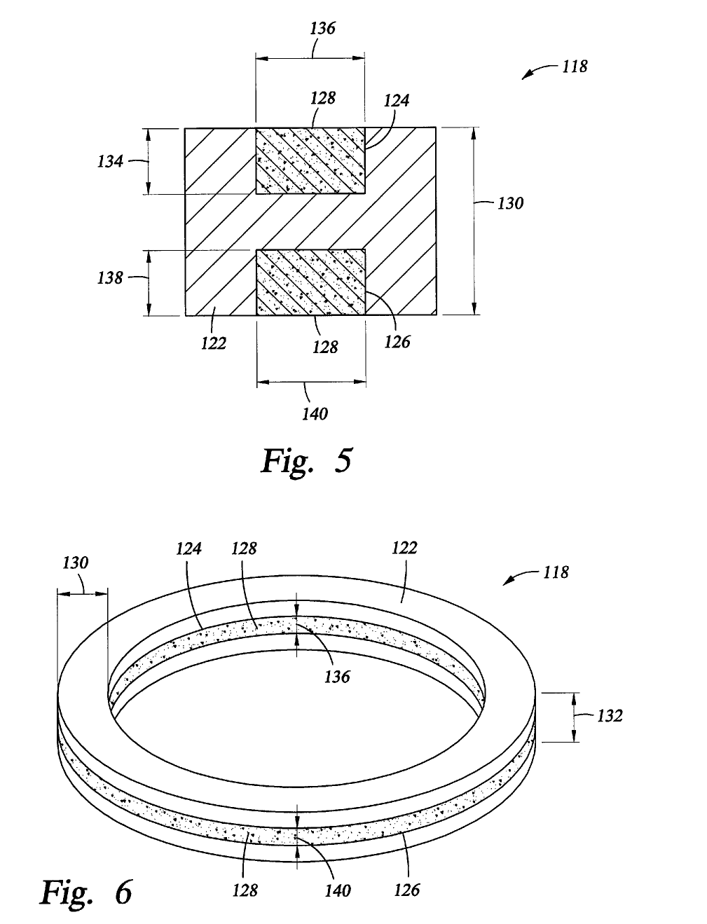

Referring now to FIGS. 5 and 6, a braze ring 118 is shown in greater detail. FIG. 5 is a partial cross-sectional side view of a braze ring 118, while FIG. 6 is an oblique view of a braze ring 118. Braze ring 118 generally comprises an H-shaped body 122 having an inner channel 124 and an outer channel 126. The braze ring 118 comprises flux 128 disposed within the inner channel 124 and the outer channel 126. The body 122 comprises a body thickness 130 that, when the braze ring 118 is installed in the heat exchanger coil 100, extends generally perpendicular to the lengthwise direction of the straight tubes 102. The body 122 further comprises a body length 132 that, when the braze ring 118 is installed in the heat exchanger coil 100, extends generally parallel to the lengthwise direction of the straight tubes 102. Similarly, the outer channel 126 comprises an outer channel depth 138 that, when the braze ring 118 is installed in the heat exchanger coil 100, extends generally perpendicular to the lengthwise direction of the straight tubes 102, while an outer channel length 140 extends generally parallel to the lengthwise direction of the straight tubes 102. Further, the inner channel 124 comprises an inner channel depth 134 that, when the braze ring 118 is installed in the heat exchanger coil 100, extends generally perpendicular to the lengthwise direction of the straight tubes 102, while an outer channel length 136 extends generally parallel to the lengthwise direction of the straight tubes 102.

It will be appreciated that the braze ring 118 may be formed of a braze wire having substantially the same cross-section as braze ring 118. In other words, a braze wire having a cross-section substantially similar to the partial cross-section shown in FIG. 5 may be bent or otherwise manipulated into the shape and form of the braze ring 118 shown in FIG. 6. In alternative embodiments, braze wire comprising a cross-section similar to that shown in FIG. 5 may also be used to produce a rod, slug, or any other custom shape. It will further be appreciated that while inner channel 124 and outer channel 126 are substantially similarly sized and shaped, in alternative embodiments of a braze ring and/or braze wire, the inner channel and outer channel may comprise different shapes from one another, may comprise different lengths and/or depths compared to one another, and may be located offset from one another along the length of a body of a braze ring and/or braze wire. Further, in other alternative embodiments, a braze ring and/or braze wire may comprise an inner channel and an outer channel having other than substantially rectangular cross-sectional shapes. For example, a braze ring and/or braze wire may comprise a V-shaped inner and/or outer channel while still providing an inner channel and an outer channel for carrying flux substantially similar to flux 128.

In some embodiments, the braze ring and/or braze wire may be constructed by first forming the body 122, complete with inner channel 124 and outer channel 126, and subsequently depositing flux 128 into the inner channel 124 and the outer channel 126. Alternatively, the braze ring and/or braze wire may be formed using simultaneous extrusion of the body and the flux. It will be appreciated that in alternative embodiments, one type of flux may be deposited into an inner channel while another type of flux is deposited into the outer channel. It will further be appreciated that in alternative embodiments, different amounts of flux may be deposited in an inner channel and outer channel of a body so that one channel carries more or less flux than the other.

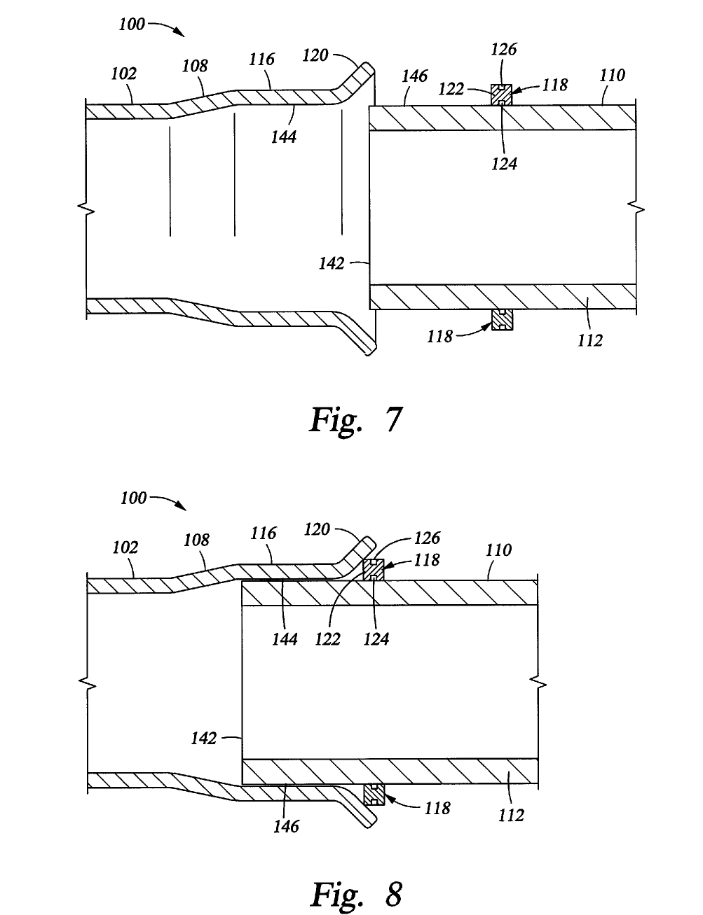

Referring now to FIGS. 7-11, a method of brazing is schematically depicted in cross-sectional side views. In particular, FIGS. 7-11 show a method for brazing and connecting a straight end 112 of a return bend 110 into a flared end 108 of a straight tube 102 of a heat exchanger coil 100. Referring now to FIG. 7, a disconnected straight tube 102 and return bend 110 are shown, with a braze ring 118 installed circumferentially around the outside of the straight end 112 of the return bend 110, offset a distance from a free end 142 of the straight end 112.

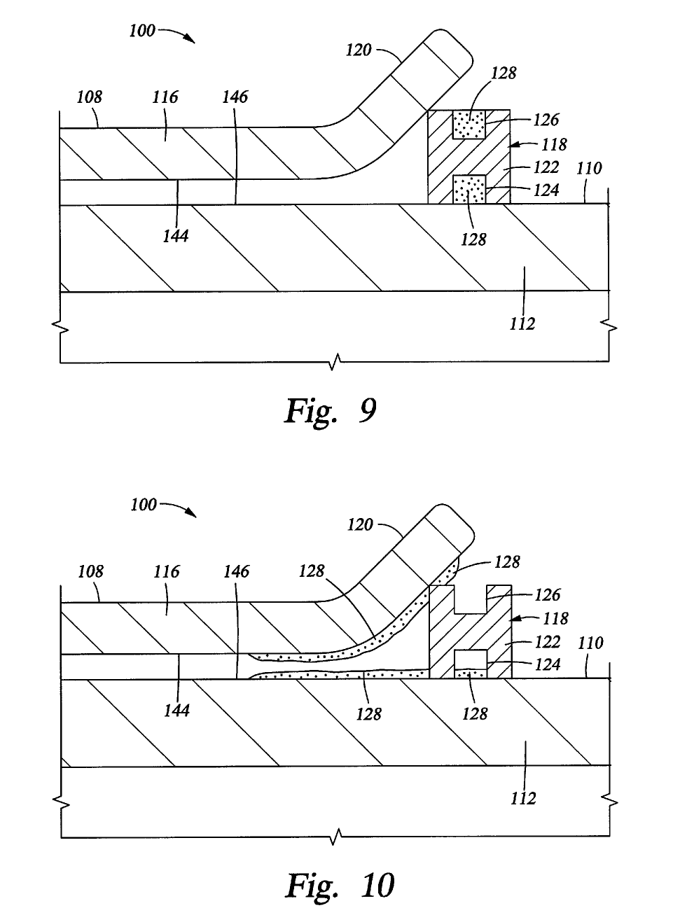

Next, as shown in FIG. 8, the straight end 112 is inserted into the flared end 108. In this configuration, the outside of the straight end 112 is received within the constant inner diameter section 116 of the straight tube 102, such that the free end 142 of the straight end 112 is as near to the straight tube 102 as allowed by the flared end 108. The straight end 112 is inserted into the flared end 108 until the lip 120 of the flared end 108 engages the braze ring 118. In that position, the straight end 112 is substantially seated within the flared end 108 by the free end 142 being stopped from further insertion into the constant inner diameter section 116 by the flared end 108, also leaving the braze ring 118 in contact with the lip 120 and positioned substantially as shown in FIG. 8. FIG. 9 depicts an enlarged, more detailed view of the arrangement of the braze ring 118 in relation to the lip 120 and the straight end 112. In the configuration depicted in FIGS. 8 and 9, the straight end 112 is in position for being brazed and connected to the flared end 108, and the braze ring 118 is in position for being melted to accomplish the brazing and connecting.

Next, the braze ring 118 and the surrounding straight end 112 and flared end 108 are heated to a temperature above a melting temperature of the flux 128 but below the melting temperatures of the flared end 108, the straight end 112, and the body 122. It will be appreciated that, generally, the flared end 108 and return bend 110 have higher melting temperatures than the body 122 and the flux 128. Still further, it will be appreciated that, generally, the body 122 has a higher melting temperature than the flux 128 carried on the body 122. As a result, and as depicted in FIG. 10, the flux 128 is caused to melt and be distributed along faying surfaces of the flared end 108 and the straight end 112, namely, the flared end faying surface 144 and the straight end faying surface 146. The flared end faying surface 144 generally faces the straight end faying surface 146, and the faying surfaces 144, 146 are generally offset from each other along the constant inner diameter section 116 by about 2 to 3 thousandths of an inch. Of course, the flared end faying surface 144 includes the portion of the lip 120 that faces the straight end 112. As the flux 128 is melted, the flux 128 of the outer channel 126 is free to flow substantially to the flared end faying surface 144, including the portion associated with the lip 120, while the flux 128 of the inner channel 124 is free to flow substantially to the straight end faying surface 146. Of course, depending on the circumstances, flux 128 from either one of the inner channel 124 and/or the outer channel 126 may contact either or both of the flared end faying surface 144 and the straight end faying surface 146. As the flux 128 is further heated, the flux 128 performs the function of preparing (removing oxidation from and/or otherwise cleaning) the flared end faying surface 144 and the straight end faying surface 146. After continued heating, the flux 128 is consumed and/or otherwise significantly dissipates from the flared end faying surface 144 and the straight end faying surface 146, leaving them prepared for being brazed.

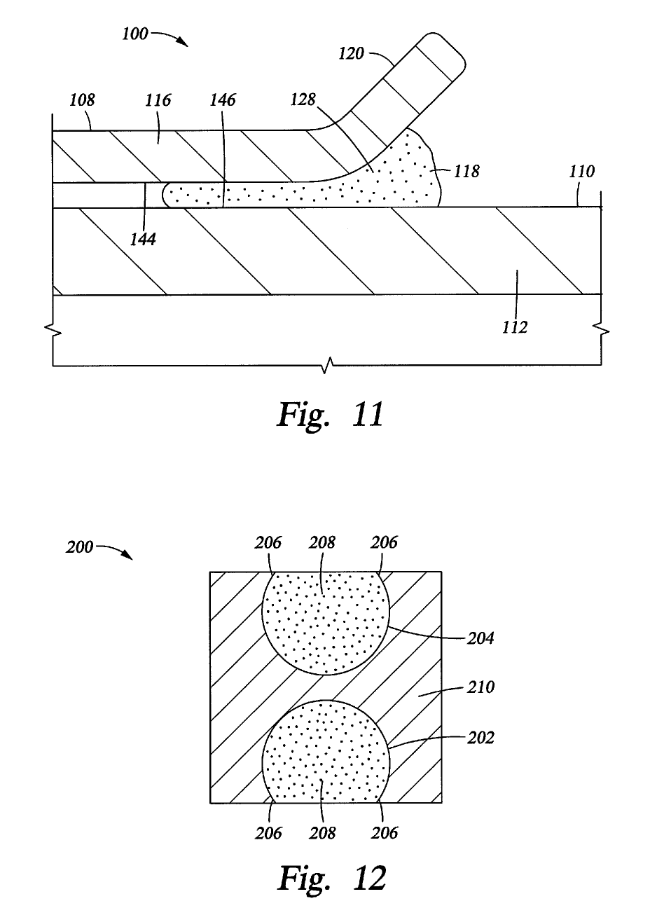

Referring now to FIG. 11, a final step in brazing and connecting the straight end 112 to the flared end 108 is accomplished by further heating the braze ring 118, which comprises little or no flux 128 remaining within the inner channel 124 and outer channel 126, leaving substantially only the body 122 to be heated. The body 122 is heated to a temperature above a melting temperature of the body 122, but below a melting temperature of either of the straight end 112 or the flared end 108. Accordingly, the previously solid form body 122 melts and becomes, at least for a moment, liquid form and flows into the space between the flared end faying surface 144 and the straight end faying surface 146. Some of the flow of the melted body 122 may be due to capillary flow effects, thereby drawing the melted body 122 toward the straight tube 102. Subsequently, heat is removed from the melted body 122, allowing the body 122 to solidify, thereby joining the straight end 112 to the flared end 108 by brazing.

In this embodiment, the flared end 108 is constructed of 3102 Aluminum Alloy while the return bend 110 is constructed of 3003 Series Aluminum. Further, in this embodiment, the body 122 of the braze ring 118 is constructed of a Zinc-Aluminum alloy while the flux 128 comprises an aluminum potassium fluoride based flux mixed with a polymer-based binder material. Of course, in alternative embodiments, the flared end and the return bend may be constructed of any other suitable materials, while a body and a flux may be selected based on their suitability for joining the flared end and the return bend by brazing. It will be appreciated that in further alternative embodiments, a flared end may be constructed of a material different than the material forming the remainder of a straight tube to which the flared end is attached. Similarly, in further alternative embodiments, a straight end of a return bend may be constructed of a material different than the material of a tubular curved link of the return bend.

In an alternative embodiment of a braze ring, the body of the braze ring is constructed of a Zinc-Aluminum alloy comprising about 78% Zinc and about 22% Aluminum resulting in an alloy having a solidus of about 826° F. and a liquidus of about 905° F. In that same embodiment, the flux comprises an aluminum potassium fluoride based flux enhanced with cesium compounds and/or salts and mixed with a polymer-based binder material. Of course, the same material components could be used to form an alternative embodiment of a braze wire or a braze ring.

In another alternative embodiment of a braze ring, the body of the braze ring is constructed of an Aluminum-Silicon alloy (4047 (#718) 88% Aluminum—12% Silicon), resulting in an alloy having a solidus of about 1070° F. and a liquidus of about 1080° F. In that same embodiment, the flux comprises an aluminum potassium fluoride based flux comprising CsₓK_{y}AlF_{z} (where x=0.02; y=1-2; z=4-5), resulting in flux having a melting range of about 558-566° C. Of course, the same material components could be used to form an alternative embodiment of a braze wire or a braze ring.

In still another alternative embodiment of a braze ring, the body of the braze ring is constructed of a Zinc-Aluminum alloy comprising about 95% Zinc and about 5% Aluminum. In that same embodiment, the flux comprises an aluminum potassium fluoride based flux enhanced with cesium compounds and/or salts and mixed with a polymer-based binder material. Of course, the same material components could be used to form an alternative embodiment of a braze wire or a braze ring.

Referring now to FIG. 12, an alternative embodiment of a braze ring 200 is shown. FIG. 12 is a partial cross-sectional side view of the braze ring 200. Braze ring 200 is substantially similar to braze ring 118 and has an inner channel 202 and an outer channel 204. However, the inner channel 202 and outer channel 204 are not defined generally by perpendicular and parallel walls of body 210 (with respect to the outer walls of the braze ring 200 cross-section). Instead, the inner channel 202 and outer channel 204 are formed by generally C-shaped walls that are open away from each other and toward the exterior of the braze ring 200 cross-section. Overhangs 206 serve to retain flux 208 within the inner channel 202 and outer channel 204. It will be appreciated that in alternative embodiments, the body 210 may be formed in any other suitable shape that provides the retaining function of overhangs 206. Body 210 may be constructed of or comprise any of the above-described material combinations as described with reference to the H-shaped body 122 and other alternative braze ring body embodiments. Further, flux 208 may be constructed of or comprise any of the above-described material combinations as described with reference to the flux 128 and other alternative flux embodiments.

As evinced by the discussion above, braze rings 118, 200, and the alternative embodiments disclosed, provide the ability to adequately wet and/or clean and/or otherwise prepare facing faying surfaces by delivering flux to the facing faying surfaces from at least an outer channel, and in other embodiments two separate channels, namely, an inner channel and an outer channel.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, R1, and an upper limit, Ru, is disclosed, any number falling within the range is specifically disclosed. In particular, the following numbers within the range are specifically disclosed: R=R1+k*(Ru—R1), wherein k is a variable ranging from 1 percent to 100 percent with a 1 percent increment, i.e., k is 1 percent, 2 percent, 3 percent, 4 percent, 5 percent, . . . , 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present invention. The discussion of a reference in the disclosure is not an admission that it is prior art, especially any reference that has a publication date after the priority date of this application. The disclosure of all patents, patent applications, and publications cited in the disclosure are hereby incorporated by reference, to the extent that they provide exemplary, procedural or other details supplementary to the disclosure.

What is claimed is:

1. A method of connecting a straight tubular end to a flared tubular end, comprising:
locating a substantially annular braze ring substantially concentrically around the straight tubular end;
inserting the straight tubular end into the flared tubular end so that the braze ring engages the flared tubular end; and
heating the braze ring so that flux separates from an exterior channel of the braze ring and the separated flux from the exterior channel contacts at least one of a faying surface of the flared tubular end and a faying surface of the straight tubular end.

2. The method according to claim 1, further comprising:
continuing to heat the separated flux from the exterior channel until the flux is substantially removed from the braze ring.

3. The method according to claim 1, further comprising:
heating the braze ring so that flux separates from an interior channel of the braze ring and the separated flux from the interior channel contacts at least one of the faying surface of the flared tubular end and the faying surface of the straight tubular end.

4. The method according to claim 3, wherein the interior channel comprises a cross-sectional shape substantially similar to the cross-sectional shape of the exterior channel.

5. The method according to claim 3, further comprising:
continuing to heat the separated flux from the exterior channel and the interior channel until the flux is substantially removed from the braze ring.

6. The method according to claim 1, further comprising:
after the separated flux has contacted at least one of the faying surface of the flared tubular end and the faying surface of the straight tubular end, melting the braze ring and increasingly contacting the melted braze ring with at least one of the faying surface of the flared tubular end and the faying surface of the straight tubular end.

7. The method according to claim 6, wherein the melted braze ring at least partially forms a seal between the faying surface of the flared tubular end and the faying surface of the straight tubular end.

8. The method according to claim 6, wherein at least a portion of the melted braze ring is transported into a space between the faying surface of the flared tubular end and the faying surface of the straight tubular end through a capillary flow action.

9. A method of brazing, comprising:
disposing a brazing material layer of a braze ring between an inner faying surface and an outer faying surface, the brazing material layer being at least partially radially positioned between an inner flux layer of the braze ring and an outer flux layer of the braze ring.

10. The method of claim 9, further comprising:
in response to heating at least a portion of the braze ring, displacing at least a portion of at least one of flux of the inner flux layer and flux of the outer flux layer from the braze ring.

11. The method of claim 10, further comprising:
preparing at least one of the inner faying surface and the outer faying surface for brazing using the displaced flux.

12. The method of claim 11, wherein the displaced flux is displaced from the inner flux layer and the displaced flux prepares the inner faying surface.

13. The method of claim 11, wherein the displaced flux is displaced from the outer flux layer and the displaced flux prepares the outer faying surface.

14. The method of claim 11, further comprising:
in response to further heating of the braze ring, melting brazing material of the braze ring.

15. The method of claim 14, further comprising joining the inner faying surface to the outer faying surface by solidifying at least some of the melted brazing material between the inner faying surface and the outer faying surface.

16. The method of claim 15, wherein at least a portion of the melted brazing material originated from the brazing material layer of the braze ring.

17. A method of brazing, comprising:
at least partially disposing a first tube substantially concentrically within a second tube, the first tube comprising an outer surface and the second tube comprising an inner surface;
at least partially disposing a braze ring substantially concentrically between the first tube and the second tube, the braze ring comprising an outer profile and an inner profile;
heating at least a portion of the braze ring to a first temperature below a melting temperature of a braze material of the braze ring; and
in response to heating the braze ring to the first temperature, altering the outer profile and altering the inner profile.

18. The method of claim 17, wherein each of altering the outer profile and altering the inner profile comprises melting at least one flux material.

19. The method of claim 17, wherein each of altering the outer profile and altering the inner profile comprises consuming at least one flux material.

20. The method of claim 17, further comprising:
after altering the outer profile and the inner profile, further heating the braze ring to melt at least a portion of the braze material of the braze ring.
